(19) United States
(12) Patent Application Publication
(10) Pub. No.: US 2026/0269108 A1
(43) Pub. Date: Sep. 10, 2026

(54) RESISTOR AND MANUFACTURING METHOD FOR RESISTOR

(71) Applicant: ROHM CO., LTD., Kyoto (JP)

(72) Inventors: Kentaro NAKA, Kyoto (JP); Yuji OKAMOTO, Kyoto (JP)

(73) Assignee: ROHM CO., LTD., Kyoto (JP)

(21) Appl. No.: 19/551,852

(22) Filed: Feb. 27, 2026

(30) Foreign Application Priority Data
Mar. 4, 2025 (JP) 2025-033773

(51) Int. Cl. H01C 1/144; H01C 1/142; H01C 17/00

(52) U.S. Cl. CPC H01C 1/144; H01C 1/142; H01C 17/006

(57) ABSTRACT

A resistor includes a resistive element, a first electrode, and a second electrode. The first electrode is disposed at a gap from the second electrode. The first electrode and the second electrode each have a top surface and a bottom surface. The resistive element is arranged so as to span from the first electrode to the second electrode on the top surface side, and is welded to the first electrode and the second electrode. Weld junctions that are formed by welding the resistive element to the first electrode and the second electrode, respectively, are formed diagonally such that the width thereof in the direction in which the first electrode and the second electrode face each other decreases from the top surface to the bottom surface.

This application is based upon and claims the benefit of priority of the prior Japanese Patent Application No. 2025-033773, filed on March 4, 2025, the entire contents of which are incorporated herein by reference.

### Technical Field

The present disclosure relates to a resistor and a manufacturing method for a resistor.

### Background Art

WO/2012/157435 discloses a manufacturing method for a chip resistor including a step for joining two conductive long boards to a resistive element long board by high-energy-beam welding. The high energy beam is emitted onto the conductive long board or the resistive element long board along the direction that the front surface faces.

### SUMMARY OF THE INVENTION

An object of the present disclosure is to provide a resistor and a manufacturing method for a resistor by which it is possible to mitigate anomalies in the solder connection due to the formation of drosses resulting from welding.

A resistor according to the present disclosure includes a resistive element, a first electrode, and a second electrode. The first electrode is disposed at a gap from the second electrode. The first electrode and the second electrode each have a top surface and a bottom surface. The resistive element is arranged so as to span from the first electrode to the second electrode on the top surface side, and is welded to the first electrode and the second electrode. Weld junctions that are formed by welding the resistive element to the first electrode and the second electrode, respectively, are formed diagonally such that the width thereof in the direction in which the first electrode and the second electrode face each other decreases from the top surface to the bottom surface.

### BRIEF DESCRIPTION OF THE DRAWINGS

FIG. 1 is a schematic perspective view of a resistor according to Embodiment 1.

FIG. 2 is a schematic cross-sectional view along the line II-II of FIG. 1.

FIG. 3 is a flowchart showing a manufacturing method for the resistor according to Embodiment 1.

FIG. 4 is a schematic cross-sectional view showing a preparation step in the manufacturing method for the resistor according to Embodiment 1.

FIG. 5 is a schematic cross-sectional view showing a welding step in the manufacturing method for the resistor according to Embodiment 1.

FIG. 6 is a schematic perspective view of a resistor according to Embodiment 2.

FIG. 7 is a schematic perspective view of a resistor according to Embodiment 3.

FIG. 8 is a schematic perspective view of a resistor according to Embodiment 4.

FIG. 9 is a schematic cross-sectional view along the line IX-IX of FIG. 8.

FIG. 10 is a schematic perspective view of a resistor according to Embodiment 5.

FIG. 11 is a schematic perspective view of a resistor according to Embodiment 6.

FIG. 12 is a schematic cross-sectional view along the line XII-XII of FIG. 11.

FIG. 13 is a schematic cross-sectional view of a resistor according to Embodiment 7.

FIG. 14 is a schematic cross-sectional view of a modification example the resistor according to Embodiment 7.

### DETAILED DESCRIPTION OF EMBODIMENTS

Embodiments will be explained in detail below with reference to the drawings. Same or similar components below are assigned the same reference characters and descriptions thereof will not be repeated.

### Embodiment 1

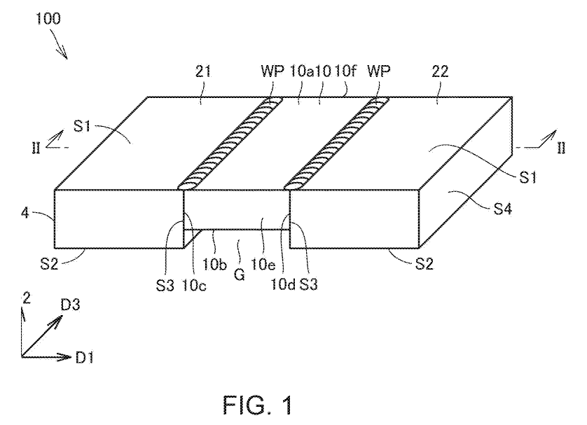

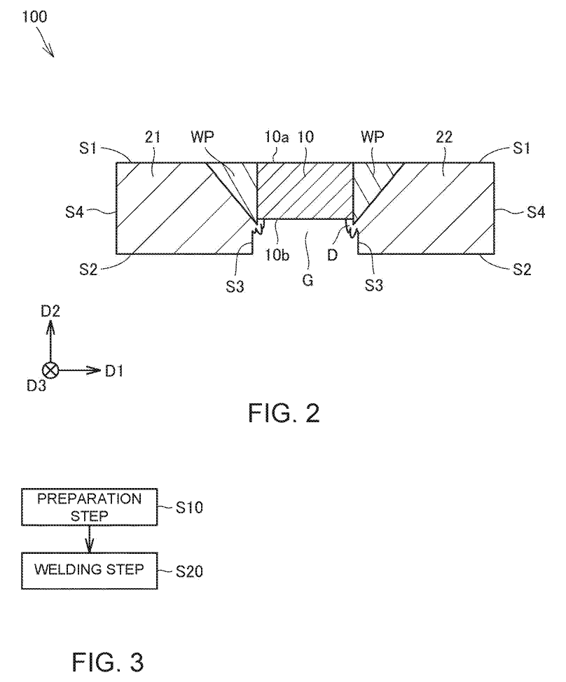

The structure of a resistor 100 according to Embodiment 1 will be described below with reference to FIGS. 1 and 2.

The resistor 100 of Embodiment 1 is a chip resistor, for example. The chip resistor is a shunt resistor, for example. The shunt resistor is used in order to measure the size of a current, for example.

The resistor 100 of Embodiment 1 includes a resistive element 10, a first electrode 21, and a second electrode 22.

The resistive element 10 is a resistive alloy such as a copper-manganese (Cu-Mn) alloy, a copper-nickel (Cu-Ni) alloy, or a nickel-chromium (Ni-Cr) alloy. The resistive element 10 has a front surface 10a and a rear surface 10b. The rear surface 10b is disposed on the side opposite to the front surface 10a. The resistive element 10 has a first side face 10c, a second side face 10d, a third side face 10e, and a fourth side face 10f. The first side face 10c is connected to the front surface 10a and the rear surface 10b. The second side face 10d is connected to the front surface 10a and the rear surface 10b. The second side face 10d is disposed on the side opposite to the first side face 10c. The third side face 10e is connected to the front surface 10a and the rear surface 10b. The fourth side face 10f is connected to the front surface 10a and the rear surface 10b. The fourth side face 10f is disposed on the side opposite to the third side face 10e. The resistive element 10 is configured as a thin plate. The resistive element 10 is configured in a rectangular cuboid shape.

A first direction D1 is a direction in which the first side face 10c and the second side face 10d face each other. The first direction D1 is also a direction in which the first electrode 21 and the second electrode 22 face each other. In the present embodiment, the first direction D1 is the lengthwise direction of the resistor 100. A second direction D2 is a direction in which the front surface 10a and the rear surface 10b face each other. In the present embodiment, the second direction D2 is the thickness direction of the resistor 100. A third direction D3 is a direction in which the third side face 10e and the fourth side face 10f face each other. In the present embodiment, the third direction D3 is the widthwise direction of the resistor 100. The front surface 10a and the rear surface 10b both extend along the first direction D1 and the third direction D3. The first direction D1 is perpendicular to the second direction D2 and the third direction D3.

The first electrode 21 is disposed at a gap from the second electrode 22. The first electrode 21 and the second electrode 22 are disposed so as to face each other in the first direction D1. The first electrode 21 and the second electrode are both copper electrodes, for example. The first electrode 21 and the second electrode 22 each have a top surface S1 and a bottom surface S2. The bottom surface S2 is disposed on the side opposite to the top surface S1. The first electrode 21 and the second electrode 22 each have an inner side face S3 and an outer side face S4. The outer side face S4 is disposed on the side opposite to the inner side face S3. The inner side face S3 of the first electrode 21 faces the first side face 10c of the resistive element 10. The inner side face S3 of the second electrode 22 faces the second side face 10d of the resistive element 10.

The resistive element 10 is arranged so as to span from the first electrode 21 to the second electrode 22 on the top surface S1 side. The resistive element 10 is welded, respectively, to the first electrode 21 and the second electrode 22. In the present embodiment, the resistive element 10 is sandwiched between the first electrode 21 and the second electrode 22. In other words, the resistive element 10 is disposed between the first electrode 21 and the second electrode 22.

Weld junctions WP that are formed by welding the resistive element 10 to the first electrode 21 and the second electrode 22, respectively, are formed diagonally such that the width thereof in the direction in which the first electrode 21 and the second electrode 22 face each other decreases from the top surface S1 to the bottom surface S2. The weld junctions WP are formed from the front surface 10a to the rear surface 10b of the resistive element 10. In the present embodiment, the weld junctions WP each have a substantially triangular cross section along the first direction D1. In other embodiments, the weld junctions WP may each have a substantially trapezoidal cross section along the first direction D1.

A gap G is provided to the rear surface 10b of the resistive element 10 on the side opposite to the front surface 10a. That is, the gap G is provided between the rear surface 10b of the resistive element 10 and the height position of the bottom surfaces S2 of the first electrode 21 and the second electrode 22. The rear surface 10b of the resistive element 10 is disposed closer to the top surface S1 than the height positions of the bottom surfaces S2 of the first electrode 21 and the second electrode 22. The height from the height position of the bottom surfaces S2 of the first electrode 21 and the second electrode 22 to the height position of the rear surface 10b of the resistive element 10 is 0.35mm to 0.5mm, for example. The height of the resistor 100 is less than 1mm, for example.

In the present embodiment, the thickness of the resistive element 10 less than the thickness of each of the first electrode 21 and the second electrode 22. That is, the second direction D2 dimension of the resistive element 10 is less than the second direction D2 dimension of each of the first electrode 21 and the second electrode 22.

Drosses D, which are melted metal formed by welding, are formed on the rear surface 10b of the resistive element 10. The drosses D are disposed in the gap G between the rear surface 10b of the resistive element 10 and the bottom surfaces S2 of the first electrode 21 and the second electrode 22. The drosses D are not formed on the bottom surfaces S2 of the first electrode 21 and the second electrode 22.

In the present embodiment, the first electrode 21 and the second electrode 22 have a bendless structure. In other words, the first electrode 21 and the second electrode 22 have a flat configuration. Specifically, the top surfaces S1 and the bottom surfaces S2 of the first electrode 21 and the second electrode 22 each have a flat configuration from the inner side face S3 to the outer side face S4.

In the present embodiment, the height position of the top surfaces S1 of the first electrode 21 and the second electrode 22 is the same as the height position of the front surface 10a of the resistive element 10. In other words, the top surfaces S1 of the first electrode 21 and the second electrode 22 are flush with the front surface 10a of the resistive element 10.

A manufacturing method for the resistor 100 according to Embodiment 1 will be described below with reference to FIGS. 3 to 5.

As shown in FIG. 3, the manufacturing method for the resistor 100 of Embodiment 1 includes a preparation step S10 and a welding step S20. In the preparation step S10, the resistive element 10, the first electrode 21, and the second electrode 22 are prepared. In the welding step S20, the resistive element 10 is welded, respectively, to the first electrode 21 and the second electrode 22.

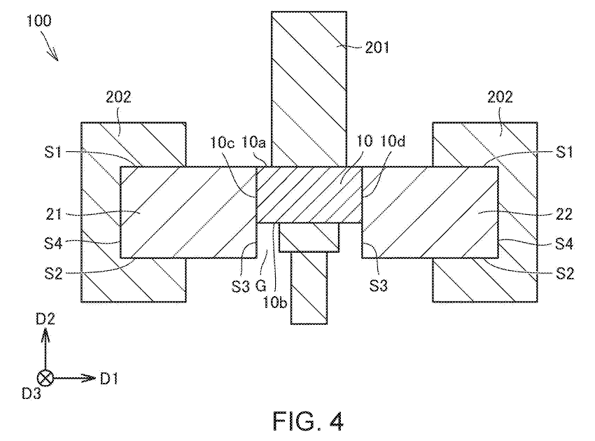

As shown in FIG. 4, during the preparation step S10, the first electrode 21 is disposed at a gap from the second electrode 22. The first electrode 21 and the second electrode 22 each have the top surface S1 and the bottom surface S2. The resistive element 10 is fixed in place by a first fixing jig 201. The front surface 10a and the rear surface 10b of the resistive element 10 are held in place by the first fixing jig 201. The first electrode 21 and the second electrode 22 are fixed in place by a second fixing jig 202. The first electrode 21 and the second electrode 22 are held by the second fixing jig 202 such that the inner side face S3 of the first electrode 21 is in contact with the first side face 10c of the resistive element 10 and the inner side face S3 of the second electrode 22 is in contact with the second side face 10d of the resistive element 10.

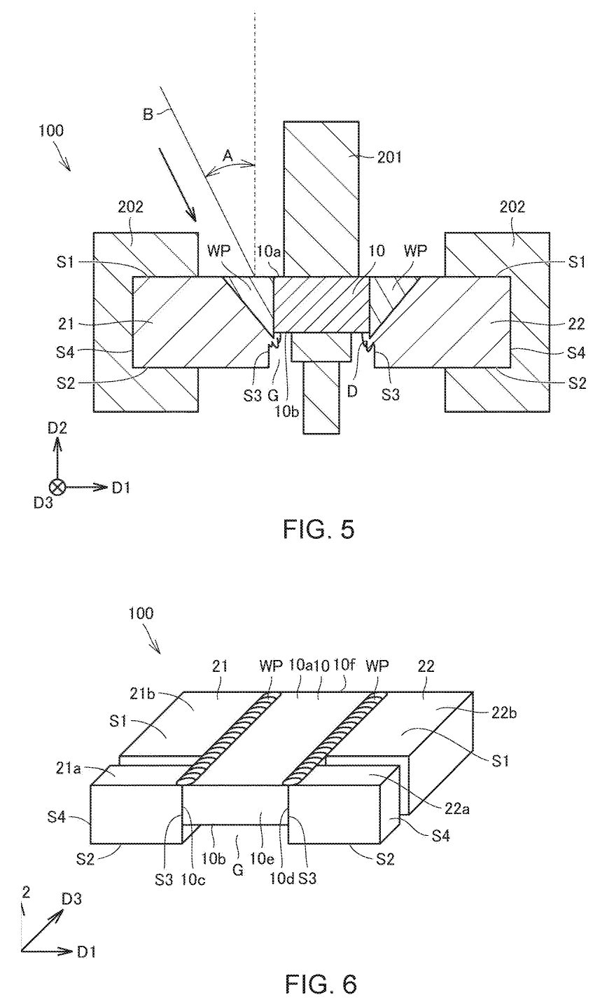

As shown in FIG. 5, during the welding step S20, the resistive element 10 is welded to the first electrode 21 and the second electrode 22 in a state of being arranged so as to span from the first electrode 21 to the second electrode 22 on the top surface S1 side. The weld junctions WP that are formed by welding the resistive element 10 to the first electrode 21 and the second electrode 22, respectively, are formed diagonally such that the width thereof in the direction in which the first electrode 21 and the second electrode 22 face each other decreases from the top surface S1 to the bottom surface S2. In the present embodiment, the weld junctions WP are respectively formed at the boundary between the inner side face S3 of the first electrode 21 and the first side face 10c of the resistive element 10 and the boundary between the inner side face S3 of the second electrode 22 and the second side face 10d of the resistive element 10.

The resistive element 10 is welded, respectively, to the first electrode 22 and the second electrode 22 by a high energy beam B. The high energy beam B is a laser beam or an electron beam. The high energy beam B is emitted onto the front surface 10a of the resistive element 10 and the top surfaces S1 of the first electrode 21 and the second electrode 22 in a direction diagonal with respect to the vertical direction. The high energy beam B passes through the resistive element 10 but does not pass through the first electrode 21 or the second electrode 22. Thus, the weld junctions WP pass through the resistive element 10 but do not pass through the first electrode 21 or the second electrode 22. Thus, the drosses D formed by welding adhere to the rear surface 10b of the resistive element 10 but do not adhere to the bottom surfaces S2 of the first electrode 21 and the second electrode 22.

The heat source for welding can be set to have as narrow a melting range as possible, and thus, it is preferable that a single-mode fiber laser, which exhibits little dross formation and sputtering resulting from spraying of melted metal, be used. Also, it is preferable that welding be performed using a device provided with a galvanometer scanner, which can adjust the melting range or adjust the emission angle.

An emission angle A of the high energy beam is the inclination angle, with respect to the vertical direction, of the high energy beam onto the front surface 10a of the resistive element 10 and the top surfaces S1 of the first electrode 21 and the second electrode 22. It is preferable that the emission angle A of the high energy beam be greater than 0° and less than or equal to 10°. It is more preferable that the emission angle A of the high energy beam be 2.6°.

In the present embodiment, the resistive element 10 is butt-welded to the first electrode 21 and the second electrode 22 in a state in which the resistive element 10 is sandwiched between the first electrode 21 and the second electrode 22.

Next, the effects of Embodiment 1 will be explained.

According to the resistor 100 of Embodiment 1, the weld junctions WP that are formed by welding the resistive element 10 to the first electrode 21 and the second electrode 22, respectively, are formed diagonally such that the width thereof in the direction in which the first electrode 21 and the second electrode 22 face each other decreases from the top surface S1 to the bottom surface S2. Thus, it is possible to mitigate the adherence of the drosses D formed by welding to the bottom surfaces S2 of the first electrode 21 and the second electrode 22. Therefore, it is possible to mitigate anomalies in the solder connection due to the formation of drosses D resulting from welding.

According to the resistor 100 of Embodiment 1, the first electrode 21 and the second electrode 22 have a bendless structure. Thus, compared to a gull-wing structure in which the first electrode 21 and the second electrode 22 are bent so as to have stepped sections with decreasing height towards the outside in the thickness direction of the resistor 100, it is possible to reduce the plan-view size of the resistor 100. It is also possible to reduce the height of the resistor 100.

The temperature coefficient of resistance (TCR) of the resistor 100 is determined by the total of the temperature coefficient of resistance of the resistive element 10 and the temperature coefficients of resistance of the first electrode 21 and the second electrode 22. The temperature coefficients of resistance of the first electrode 21 and the second electrode 22 are very large, and thus, the temperature coefficients of resistance of the first electrode 21 and the second electrode 22 have a high impact on the temperature coefficient of resistance of the resistor 100. The distance from the weld junctions WP to the bottom surfaces S2 of the first electrode 21 and the second electrode 22, which are ground surfaces, is shorter in a bendless structure than in a gull-wing structure. Thus, in the resistor 100 of Embodiment 1, because the first electrode 21 and the second electrode 22 have a bendless structure, the resistor 100 has excellent low-temperature coefficient of resistance characteristics.

According to the manufacturing method for the resistor 100 of Embodiment 1, during the welding step S20, the resistive element 10 is welded to the first electrode 21 and the second electrode 22 in a state of being arranged so as to span from the first electrode 21 to the second electrode 22 on the top surface S1 side. The weld junctions WP that are formed by welding the resistive element 10 to the first electrode 21 and the second electrode 22, respectively, are formed diagonally such that the width thereof in the direction in which the first electrode 21 and the second electrode 22 face each other decreases from the top surface S1 to the bottom surface S2. Thus, it is possible to mitigate the adherence of the drosses formed by welding to the bottom surfaces S2 of the first electrode 21 and the second electrode 22. Therefore, it is possible to mitigate anomalies in the solder connection due to the formation of drosses resulting from welding.

It is possible to perform welding while preventing the high energy beam B from hitting the first fixing jig 201, which fixes in place the resistive element 10, and the second fixing jig 202, which fixes in place the first electrode 21 and the second electrode 22. As a result, it is possible to further reduce the plan-view size of the resistor 100.

### Embodiment 2

The configuration and manufacturing method of Embodiment 2 differ from the configuration and manufacturing method of Embodiment 1 in the following respects. In other respects, the configuration and manufacturing method of Embodiment 2 are similar to those of Embodiment 1. The components of Embodiment 1 may be freely combined therewith.

The structure of a resistor 100 according to Embodiment 2 will be described below with reference to FIG. 6.

The resistor 100 according to Embodiment 2 has a four-terminal shape. That is, the resistor 100 of Embodiment 2 includes four terminals.

In the resistor 100 of Embodiment 2, the first electrode 21 includes a first terminal 21a and a second terminal 21b. The second electrode 22 includes a third terminal 22a and a fourth terminal 22b. The first terminal 21a is disposed at a gap from the second terminal 21b in the third direction D3. The third terminal 22a is disposed at a gap from the fourth terminal 22b in the third direction D3. The third terminal 22a is disposed so as to face the first terminal 21a in the first direction D1. The fourth terminal 22b is disposed so as to face the second terminal 21b in the first direction D1.

In the present embodiment, the first terminal 21a has the same shape as the third terminal 22a. Also, the second terminal 21b has the same shape as the fourth terminal 22b. The first terminal 21a and the third terminal 22a are arranged in line symmetry about the resistive element 10, and the second terminal 21b and the fourth terminal 22b are arranged in line symmetry about the resistive element 10. More specifically, the first terminal 21a and the third terminal 22a are arranged in line symmetry about a central line extending in the third direction through the center of the resistive element 10 in the first direction D1, and the second terminal 21b and the fourth terminal 22b are arranged in line symmetry about the central line.

Next, the effects of Embodiment 2 will be explained.

According to the resistor 100 of Embodiment 2, the first electrode 21 includes the first terminal 21a and the second terminal 21b. The second electrode 22 includes the third terminal 22a and the fourth terminal 22b. Thus, the resistor 100 has four terminals including the first terminal 21a, the second terminal 21b, the third terminal 22a, and the fourth terminal 22b. Therefore, it is possible to realize high precision measurement by the four-terminal method.

### Embodiment 3

The configuration and manufacturing method of Embodiment 3 differ from the configuration and manufacturing method of Embodiment 1 in the following respects. In other respects, the configuration and manufacturing method of Embodiment 3 are similar to those of Embodiment 1. The components of Embodiment 1 and Embodiment 2 may be freely combined therewith.

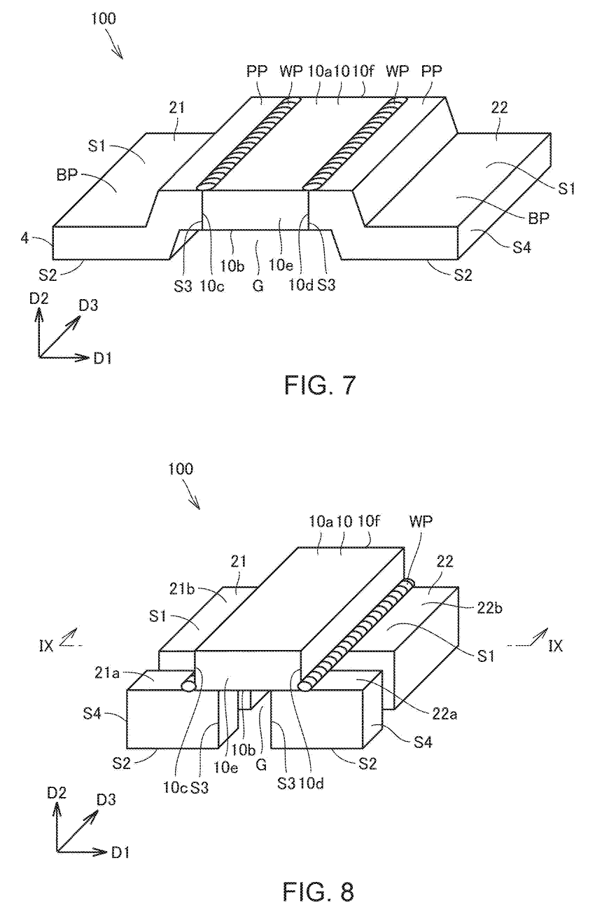

The structure of a resistor 100 according to Embodiment 3 will be described below with reference to FIG. 7.

The resistor 100 of Embodiment 3 is of the gull-wing type. That is, in the resistor 100 of Embodiment 3, the first electrode 21 and the second electrode 22 each have a gull-wing structure. The first electrode 21 and the second electrode 22 each have an outward-bending structure.

In the resistor 100 of Embodiment 3, the first electrode 21 and the second electrode 22 each have a base portion BP and a projecting portion PP. The projecting portions PP include the weld junctions WP. The projecting portion PP projects from the base portion BP towards the top surface S1. The first electrode 21 and the second electrode 22 each have a stepped section configured such that the height decreases towards the outside. The gap G is arranged between the rear surface 10b of the resistive element 10 and the height position of the bottom surfaces S2 on the outer portions of the first electrode 21 and the second electrode 22.

Next, the effects of Embodiment 3 will be explained.

According to the resistor 100 of Embodiment 3, the projecting portion PP includes the weld junction WP and protrudes from the base portion BP towards the top surface S1. Thus, the resistor 100 can be provided with a gull-wing structure. Also, the resistor 100 of Embodiment 3 can have a reduced size compared to conventional gull-wing structures.

### Embodiment 4

The configuration and manufacturing method of Embodiment 4 differ from the configuration and manufacturing method of Embodiment 1 and Embodiment 2 in the following respects. In other respects, the configuration and manufacturing method of Embodiment 4 are similar to those of Embodiment 1 and Embodiment 2. The components of Embodiment 1 to Embodiment 3 may be freely combined therewith.

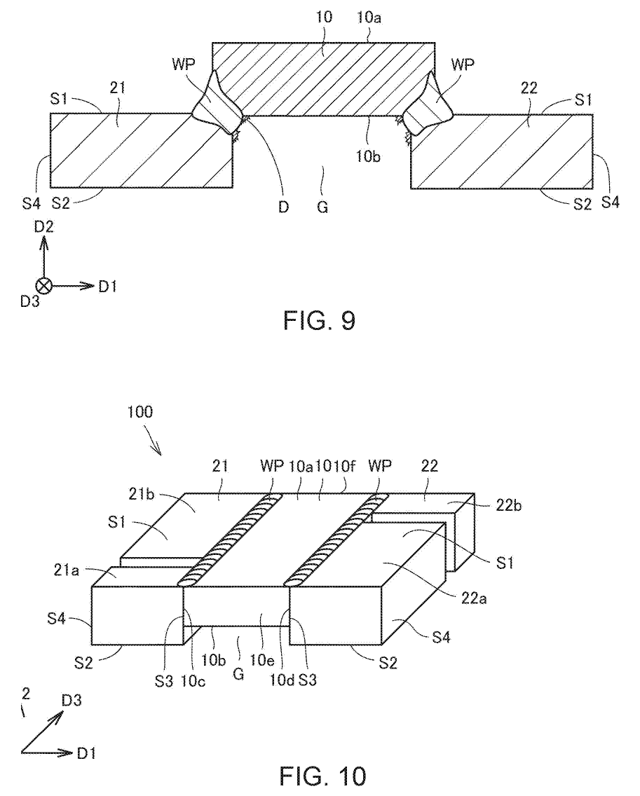

The structure of a resistor 100 according to Embodiment 4 will be described below with reference to FIGS. 8 and 9.

In the resistor 100 of Embodiment 4, the resistive element 10 is disposed on the top surfaces S1 of the first electrode 21 and the second electrode 22. The resistive element 10 is disposed so as to straddle the top surfaces S1 of the first electrode 21 and the second electrode 22. The weld junctions WP are formed by welding the resistive element 10 to the first electrode 21 and the second electrode 22, respectively. As shown in FIG. 9, the weld junctions WP are formed diagonally such that the width thereof in the direction in which the first electrode 21 and the second electrode 22 face each other decreases in the plane defined by directions D1 and D2.

The weld junctions WP can be trapezoidal or substantially trapezoidal in shape. Specifically, a first end of a weld junction WP joining the resistive element 10 and the first electrode 21 can be longer than a second end of the weld junction WP joining the resistive element 10 and first electrode 21. The first end can extend between a side surface of the resistive element 10 and the top surface S1 of the first electrode 21. The second end can extend between the rear surface 10b of the resistive element 10 and a side surface of the first electrode 21. On a corner of the first electrode 21, a first side of the weld junction WP can extend between the first end and the second end, and overlap the corner of the first electrode 21. On a corner of the resistive element 10, a second side of the weld junction WP can extend between the first end and the second end, and overlap the corner of the resistive element 10. The first side and the second side of the weld junction WP can be of substantially the same length, and can both be longer than the first end and the second end of the weld junction WP.

A weld junction WP joining the resistive element 10 and the second electrode 22 can have substantially the same shape and location as the weld junction WP joining the resistive element 10 and the first electrode 21, but with an orientation that mirrors an orientation of the weld junction WP joining the resistive element 10 and the first electrode 21. More specifically, the width of the weld junction WP joining the resistive element 10 and the second electrode 22 decreases in the plane defined by directions D1 and D2, but in an opposite D1 direction from the D1 direction in which the width of the weld junction WP joining the resistive element 10 and the first electrode 21 decreases.

In the present embodiment, the resistive element 10 is lap-welded to the first electrode 21 and the second electrode 22 in a state in which the resistive element 10 is disposed on the top surfaces S1 of the first electrode 21 and the second electrode 22.

Next, the effects of Embodiment 4 will be explained.

In the resistor 100 of Embodiment 4, the resistive element 10 is disposed on the top surfaces S1. Thus, it is possible to shorten the length of the resistor 100 in the first direction D1 compared to a case in which the resistive element 10 is sandwiched between the first electrode 21 and the second electrode 22 in the direction in which the first electrode 21 and the second electrode 22 face each other (first direction D1). Thus, it is possible to further reduce the size of the resistor 100 in a plan view.

### Embodiment 5

The configuration and manufacturing method of Embodiment 5 differ from the configuration and manufacturing method of Embodiment 1 and Embodiment 2 in the following respects. In other respects, the configuration and manufacturing method of Embodiment 5 are similar to those of Embodiment 1 and Embodiment 2. The components of Embodiment 1 to Embodiment 4 may be freely combined therewith.

The structure of a resistor 100 according to Embodiment 5 will be described below with reference to FIG. 10.

In the resistor 100 of Embodiment 5, the first terminal 21a and the third terminal 22a are arranged in point symmetry about the resistive element 10, and the second terminal 21b and the fourth terminal 22b are arranged in point symmetry about the resistive element 10. More specifically, in a plan view, the first terminal 21a and the third terminal 22a are arranged in point symmetry about the center of the resistive element 10, and the second terminal 21b and the fourth terminal 22b are arranged in point symmetry about the center of the resistive element 10.

Next, the effects of Embodiment 5will be explained.

In the resistor 100 of Embodiment 5, the first terminal 21a and the third terminal 22a are arranged in point symmetry about the resistive element 10, and the second terminal 21b and the fourth terminal 22b are arranged in point symmetry about the resistive element 10. Thus, there is no need for the direction of current flow to match the direction of current detection. Thus, it is easy to install the resistor 100.

### Embodiment 6

The configuration and manufacturing method of Embodiment 6 differ from the configuration and manufacturing method of Embodiment 1 in the following respects. In other respects, the configuration and manufacturing method of Embodiment 6 are similar to those of Embodiment 1. The components of Embodiment 1 to Embodiment 5 may be freely combined therewith.

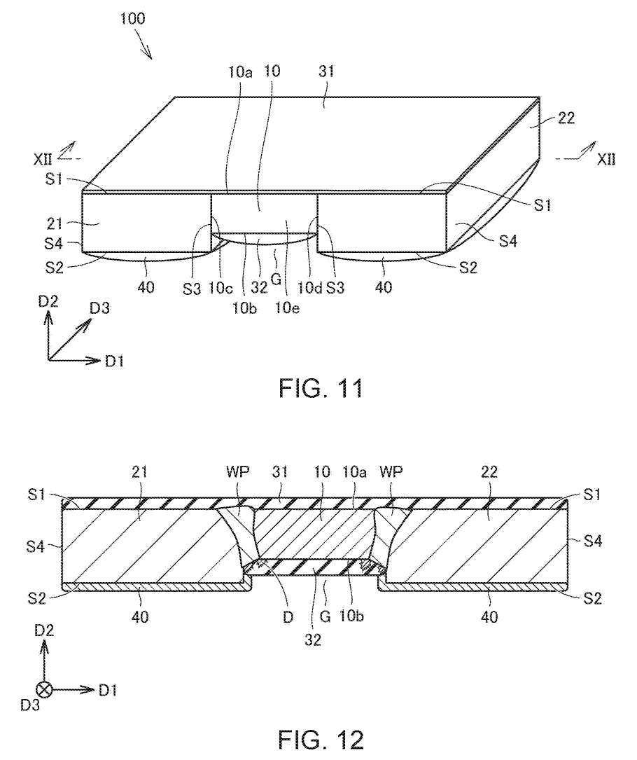

The structure of a resistor 100 according to Embodiment 6 will be described below with reference to FIGS. 11 and 12.

In the resistor 100 of Embodiment 6, a resin coating 31, 32 is formed on the top surfaces S1 the first electrode 21 and the second electrode 22, and on the front surface 10a and the rear surface 10b of the resistive element 10. The resin coating 31, 32 is configured to cover the top surfaces S1 of the first electrode 21 and the second electrode 22 and the front surface 10a and the rear surface 10b of the resistive element 10. The resin coating 31, 32 is formed over the entirety of the top surfaces S1 of the first electrode 21 and the second electrode 22 and of the front surface 10a and the rear surface 10b of the resistive element 10. A plating 40 is formed on the bottom surfaces S2 of the first electrode 21 and the second electrode 22. The plating 40 is formed on the entirety of the bottom surfaces S2 of the first electrode 21 and the second electrode 22. The plating 40 is tin plating, for example.

Next, the effects of Embodiment 6 will be explained.

In the resistor 100 of Embodiment 6, the resin coating 31, 32 is formed on the top surfaces S1 the first electrode 21 and the second electrode 22, and on the front surface 10a and the rear surface 10b of the resistive element 10. Thus, the insulation can be improved by the resin coating 31, 32. The plating 40 is formed on the bottom surfaces S2 of the first electrode 21 and the second electrode 22. Thus, it is possible to improve the solder wettability of the first electrode 21 and the second electrode 22 by the plating 40. Therefore, it is possible to improve insulation by the resin coating31, 32 and to improve the solder wettability of the first electrode 21 and the second electrode 22 by the plating 40.

### Embodiment 7

The configuration and manufacturing method of Embodiment 7 differ from the configuration and manufacturing method of Embodiment 1 in the following respects. In other respects, the configuration and manufacturing method of Embodiment 7 are similar to those of Embodiment 1. The components of Embodiment 1 to Embodiment 6 may be freely combined therewith.

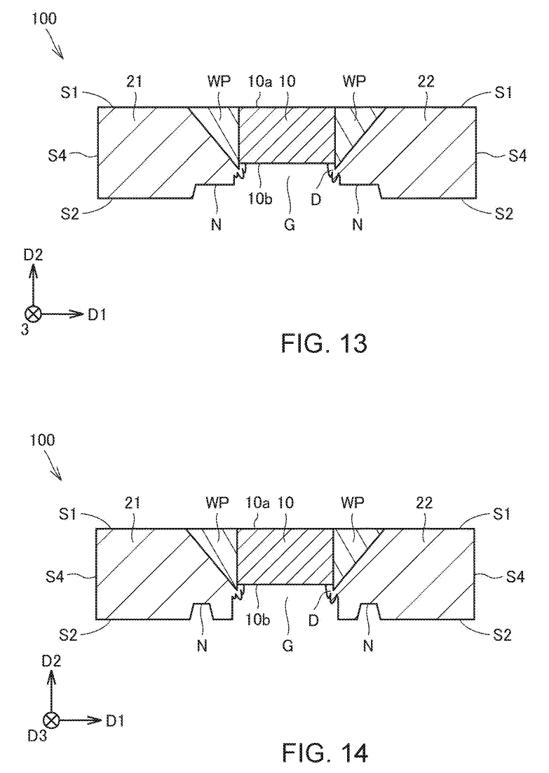

The structure of a resistor 100 according to Embodiment 7 will be described below with reference to FIG. 13.

In the resistor 100 of Embodiment 7, notches N are formed in the respective bottom surfaces S2 of the first electrode 21 and the second electrode 22. The notches N are formed from the bottom surfaces S2 of the first electrode 21 and the second electrode 22 to the inner side faces S3. The notches N extend in the third direction D3. In the second direction D2, the depth dimension of the notches N is less than the distance dimension from the bottom surfaces S2 of the first electrode 21 and the second electrode 22 to the rear surface 10b of the resistive element 10.

A modification example of the structure of a resistor 100 according to Embodiment 7 will be described below with reference to FIG. 14.

In the modification example of the resistor 100 of Embodiment 7, the notches N are formed away from the inner side faces S3 of the first electrode 21 and the second electrode 22. The notches N are disposed closer to the inner side face S3 than to the outer side face S4 in each of the first electrode 21 and the second electrode 22.

Next, the effects of Embodiment 7 will be explained.

In the resistor 100 of Embodiment 7, the notches N are formed in the respective bottom surfaces S2 of the first electrode 21 and the second electrode 22. Thus, when forming a solder connection, it is possible for solder to enter the notches N. Therefore, it is possible to mitigate solder climbing in the resistor 100.

The embodiments disclosed herein are examples in all respects, and should not be considered to be limiting. The scope of the disclosure is determined by the claims rather than the description above, and it is intended that all modifications within the equivalent meaning and scope of the claims are included.

Various aspects of the disclosure will be summarized in notes below.

### Note 1

A resistor, comprising:

a resistive element;

a first electrode; and

a second electrode,

wherein the first electrode faces the second electrode at a gap therefrom,

wherein the first electrode and the second electrode each have a top surface and a bottom surface,

wherein the resistive element is arranged so as to span from the first electrode to the second electrode on the top surface side, and is welded to the first electrode and the second electrode, respectively, and

wherein weld junctions that are formed where the resistive element is welded to the first electrode and the second electrode, respectively, are formed diagonally such that a width thereof in a direction in which the first electrode and the second electrode face each other decreases from the top surface to the bottom surface.

### Note 2

The resistor according to Note 1,

wherein the first electrode and the second electrode have a bendless structure.

### Note 3

The resistor according to Note 1 or 2,

wherein the first electrode includes a first terminal and a second terminal, and

wherein the second electrode includes a third terminal and a fourth terminal.

### Note 4

The resistor according to Note 1,

wherein the first electrode and the second electrode each have a base portion and a projecting portion, and

wherein the projecting portion includes the weld junction and protrudes from the base portion towards the top surface.

### Note 5

The resistor according to Note 1 or 2,

wherein the resistive element is disposed over the top surfaces.

### Note 6

The resistor according to Note 3,

wherein the first terminal and the third terminal are arranged in point symmetry about the resistive element, and the second terminal and the fourth terminal are arranged in point symmetry about the resistive element.

### Note 7

The resistor according to Note 1 or 2,

wherein the resistive element has a front surface and a rear surface,

wherein a resin coating is formed on the top surfaces of the first electrode and the second electrode and on the front surface and the rear surface of the resistive element, and

wherein a plating is formed on the bottom surfaces of the first electrode and the second electrode.

### Note 8

The resistor according to any one of Notes 1 to 7,

wherein notches are formed in the bottom surfaces of the first electrode and the second electrode.

### Note 9

A manufacturing method for a resistor, comprising:

a preparation step of preparing a resistive element, a first electrode, and a second electrode; and

a welding step of welding the resistive element to the first electrode and the second electrode, respectively,

wherein, in the preparation step,

the first electrode faces the second electrode at a gap therefrom, and

the first electrode and the second electrode each have a top surface and a bottom surface, and

wherein, in the welding step,

the resistive element is welded to the first electrode and the second electrode in a state of being arranged so as to span from the first electrode to the second electrode on the top surface side, and

weld junctions that are formed where the resistive element is welded to the first electrode and the second electrode, respectively, are formed diagonally such that a width thereof in a direction in which the first electrode and the second electrode face each other decreases from the top surface to the bottom surface.

What is claimed is:

1. A resistor, comprising:
a resistive element;
a first electrode; and
a second electrode,
wherein the first electrode faces the second electrode across a gap between the first electrode and the second electrode,
wherein the first electrode and the second electrode each have a top surface and a bottom surface,
wherein the resistive element is arranged so as to span from the first electrode to the second electrode on a top surface side, and is welded to the first electrode and the second electrode, respectively, and
wherein weld junctions that are formed where the resistive element is welded to the first electrode and the second electrode, respectively, are formed diagonally such that a width of the weld junctions in a direction in which the first electrode and the second electrode face each other decreases from the top surface to the bottom surface.

2. The resistor according to claim 1,
wherein the first electrode and the second electrode have a bendless structure.

3. The resistor according to claim 1,
wherein the first electrode includes a first terminal and a second terminal, and
wherein the second electrode includes a third terminal and a fourth terminal.

4. The resistor according to claim 1,
wherein the first electrode and the second electrode each have a base portion and a projecting portion, and
wherein the projecting portion includes a weld junction and protrudes from the base portion towards the top surface.

5. The resistor according to claim 1,
wherein the resistive element is disposed over the top surface of the first electrode and the top surface of the second electrode.

6. The resistor according to claim 3,
wherein the first terminal and the third terminal are arranged in point symmetry about the resistive element, and the second terminal and the fourth terminal are arranged in point symmetry about the resistive element.

7. The resistor according to claim 1,
wherein the resistive element has a front surface and a rear surface,
wherein a resin coating is formed on the top surface of the first electrode and the top surface of the second electrode and on the front surface and the rear surface of the resistive element, and
wherein a plating is formed on the bottom surface of the first electrode and the bottom surface of the second electrode.

8. The resistor according to claim 1,
wherein notches are formed in the bottom surface of the first electrode and the bottom surface of the second electrode.

9. A manufacturing method for a resistor, comprising:
a preparation step of preparing a resistive element, a first electrode, and a second electrode; and
a welding step of welding the resistive element to the first electrode and the second electrode, respectively,
wherein, in the preparation step,
the first electrode faces the second electrode across a gap between the first electrode and the second electrode, and
the first electrode and the second electrode each have a top surface and a bottom surface, and
wherein, in the welding step,
the resistive element is welded to the first electrode and the second electrode in a state of being arranged so as to span from the first electrode to the second electrode on a top surface side, and
weld junctions that are formed where the resistive element is welded to the first electrode and the second electrode, respectively, are formed diagonally such that a width of the weld junctions in a direction in which the first electrode and the second electrode face each other decreases from the top surface to the bottom surface.
